(19) United States
(12) Patent Application Publication
(10) Pub. No.: US 2004/0246505 A1
(43) Pub. Date: Dec. 9, 2004

(54) Print apparatus and automatic display language setting method therefor

(76) Inventor: Jeong-seok Oh, Suwon-city (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/784,172

(22) Filed: Feb. 24, 2004

(30) Foreign Application Priority Data
Jun. 4, 2003 (KR) 2003-36126

(51) Int. Cl. G06F 15/00

(52) U.S. Cl. 358/1.1; 358/1.13

(57) ABSTRACT

Disclosed is a print apparatus and an automatic display language setting method. The automatic display language setting method for a print apparatus connected to a host device through a communication interface and communicating with the host device through the communication interface, comprises the steps of determining whether certain language information has been received through the communication interface from the host device; and setting up a display language of a print apparatus, if it is determined that the language information has been received from the host device, to display information on a display unit of the print apparatus in a language corresponding to the language information. Accordingly, since the present invention can automatically set up the display language of the print apparatus based on information provided from the host device, convenient manipulations of the printer can be provided to the users.

### CROSS-REFERENCE TO RELATED APPLICATIONS

This application claims the benefit of Korean Patent Application No. 2003-36126, dated Jun. 4, 2003, in the Korean Intellectual Property Office, the disclosure of which is incorporated herein by reference.

### BACKGROUND

1. Field of the Invention

The present invention relates to a printing apparatus such as a printer and a combination machine and an automatic display language setting method therefor, and more particularly, to a printing apparatus and an automatic display language setting method which enables a user to set up, through a host device, a display language for displaying information on a display panel of the printing apparatus.

2. Description of the Related Art

In general, a print function is commonly provided to all printers, photocopiers, and multi-function peripherals (MFPs) capable of performing the combined function of a printer and photocopier. Of these devices, the printer is the most common printing apparatus, printing information processed in external devices such as computers or scanners. Printers receives documents prepared in an application program of the computer and print the documents according to predefined print conditions.

In the event that a user prints documents prepared for print in an application program of a computer as above, a printer driver should be installed in the computer to control the drives of the computer. The printer driver serves as a converter converting print data prepared in an application program of a computer into a data format which can be interpreted in the printer. Further, the printer driver provides a printer driver registration information setting window in order for a user to be able to set up various print information for to-be-printed documents (referred to as “print document”, where applicable).

Printers are provided with a key input part and a display part which serves as interface for data with a user. The key input part has a plurality of keys for a user to set up functions the printer supports, and the display part displays menu information set in the printer, and message information notifying the user of the operational status of the printer.

Printer manufacturers distribute or market printers pre-set with information such as menus set in the printers, messages notifying of the operational status of the printers, among other information, which is displayed on the display part of the printers in the language used in the country where the printers are sold. By setting up printers to display menus and messages prepared in different languages on a country-by-country basis as described above, the printer manufacturers expend a great deal of time (and subsequently money) to development menus suitable for each country's language, and additionally have to set up firmware prepared in different languages for each computer. Preparing the menus in different languages and firmware causes the problem of complicating the printer production process.

Accordingly, printer manufacturers have provided printers with firmware prepared in multiple languages, when putting them in the market, to enable a user to select firmware prepared for the user's desired language, out of firmwares prepared in different languages, when the user uses a printer after purchasing it. Therefore, a user can set up a display language for information to be displayed on the display part of a printer when using the menu key, a setting key, a selection key, and among others, of the key input part provided on the printer. The user must repeatedly manipulate the keys provided on the key input part, however, in order to select the desired language, which causes the user to experience an inconvenience in manipulating the keys.

### SUMMARY

In accordance with an embodiment of the present invention, provided are a printing apparatus and an automatic display language setting method capable of automatically setting up display information to be displayed on a display panel of the print apparatus based on language information transferred from a host device.

In order to achieve the above described embodiment and others, a print apparatus is provided which comprises a display unit, an interface capable of communicating with a host device, and a control unit for deciding whether to receive certain language information from the host device through the interface, and, if it is decided that the language information is received, displaying display information to be displayed on the display unit in a language corresponding to the language information.

The language information is display language information of a device driver set when the device driver is installed in the host device to control operation of the printing apparatus.

The information to be displayed on the display unit includes menu information, option information, and message information displaying operational status of the print apparatus which are set in the print apparatus.

In order to achieve the embodiment described above, an automatic display language setting method is provided for a print apparatus connected to a host device through a communication interface and which communicates with the host device through the communication interface, wherein the method comprises the steps of deciding whether to receive certain language information through the communication interface from the host device; and setting up a display language of a print apparatus. The method sets up the display language of the print apparatus to display information to be displayed on a display unit of the print apparatus in a language corresponding to the language information if it is decided that the language information is received from the host device.

The language information received from the host device is display language information of a device driver which is set when the device driver for controlling operation of the print apparatus is set up in the host device.

Examples of print apparatuses include a facsimile machine, a printer, and a combination device providing functions of the facsimile machine and the printer.

Further, in order to achieve the embodiments described above, the automatic display language setting method for a print apparatus in a print system having a host device connected through the print apparatus and a communication interface comprises the steps of sending to the print apparatus display language information of a device driver which is set when the device driver for controlling operation of the print apparatus is set up in the host device, and deciding whether to receive the display language information of the device driver from the host device. The method for setting the display language further includes setting up a display language of the print apparatus to display information to be displayed on a display unit of the print apparatus in a language corresponding to the display language information of the device driver if it is decided that the display language information of the device driver is received from the host device.

In another embodiment of the present invention, the sending step comprises the steps of setting up the device driver in a memory of the host device if an installation command for the device driver is received, selecting the display language of the device driver, and sending to the print apparatus the display language information of the device driver to set up the display language of the print apparatus in the same language as the display language of the device driver.

### BRIEF DESCRIPTION OF THE DRAWINGS

The embodiments of the present invention will be described in detail with reference to the following drawings in which like reference numerals refer to like elements, and wherein:

FIG. 1 is a block diagram illustrating a print system according to a preferred embodiment of the present invention; and

FIG. 2 is a flow chart illustrating an automatic display language setting method for a printer in the print system shown in FIG. 1.

### DETAILED DESCRIPTION OF THE PREFERRED EMBODIMENT

Hereinafter, the embodiments of the present invention will be described in detail with reference to the attached drawings.

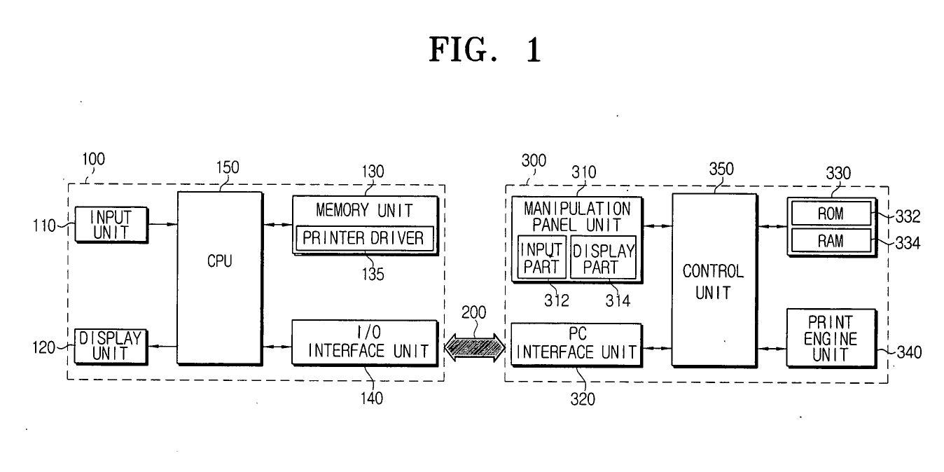

FIG. 1 is a block diagram for showing a print system according to a preferred embodiment of the present invention. In the description made below, the discussion will be made in reference to a printer in a print system connected to a host device through a communication interface. Those skilled in the art of the present invention will recognize, however, that this is but one exemplary embodiment, and the invention is not to be limited to just that example.

Referring to FIG. 1, a print system is provided with a computer 100 as a host device and a printer 300 as a print apparatus. As shown in FIG. 1, the computer 100 and the printer 300 are connected to each other through a communication interface 200.

The computer 100 has a general input unit 110, a display unit 120, a memory unit 130, an input/output (I/O) interface unit 140, and a central processing unit (CPU) 150.

The input unit 110 is a key input device such as a keyboard, and applies a key input signal based on a key input to the CPU 150.

The display unit 120 displays the operational status of the computer 100 according to the controls of the CPU 150. The display unit 120 is, typically, a monitor, and can also be a cathode ray tube (CRT) or a liquid crystal display (LCD).

The memory unit 130 is constructed with a ROM for storing the operating programs for the CPU 150 which are necessary to perform the functions of the computer 100, general control programs, and a printer driver 135. The memory unit 130 further includes a RAM for temporarily storing data as needed by the CPU 150 as it runs programs. The printer driver 135 (as an application program supporting the print performance of the printer 300), converts to-be-printed files prepared in an application program of the computer 100 into image data that the printer 300 can recognize, temporarily stores that data in the RAM of memory unit 130, and transfers the image data to the printer 300.

The printer driver 135 also provides a printer driver registration information setting window which is a user interface message for a user to set up various print information to be used in printing documents. The printer driver registration information setting window is displayed in a language set in a printer driver program setting process. In general, it is designed to automatically set up a display language set in the printer driver 135 to a language suitable for the environment of computer operating system (e.g., Windows). The display language of the printer is not limited to the computer operating system environment, and it has been designed to enable a user to select his or her desired language out of multiple languages that the printer driver 135 supports. The printer driver 135 displays the printer driver registration information setting window in a language corresponding to the set display language according to a request signal for the printer driver registration information setting window. Further, the printer driver 135 sends to the printer 300 language information corresponding to the display language set according to the controls of the CPU 150.

The I/O interface unit 140 is provided to communicate with the printer through the communication interface 200, and supports mutual data communications between the CPU 150 and the printer 300. The I/O interface unit 140 sends print data and print information according to the controls of the CPU 150.

The CPU 150 controls overall operations of the computer 100 based on the operating programs stored in the memory unit 130.

The printer 300 includes a manipulation panel unit 310, a PC interface unit 320, a memory unit 330, a print engine unit 340, and a control unit 350.

The manipulation panel unit 310 has an input part 312 provided with a plurality of keys enabling a user to select diverse print functions the printer 300 supports, and a display part 314 for displaying the operational status of the printer 300 according to the controls of the control unit 350.

The PC interface unit 320 is provided to communicate with the computer 100 through the communication interface 200, and supports mutual data communications between the computer 100 and the control unit 350. The PC interface 320 receives data transferred from the computer 100 through the communication interface 200, or sends data transferred from the control unit 350 to the computer 100 through the communication interface 200.

The memory unit 330 has a ROM 332, which is a non-volatile memory device, for storing various control programs necessary to perform the functions of the printer 300, and a RAM 334, which is a volatile memory device, for temporarily storing data as needed during the execution of the programs of the control unit 350. Further, the memory unit 130 stores firmware information corresponding to multiple languages the printer driver 135 supports.

The print engine unit 340 carries out print jobs for printing data according to the controls of the control unit 350.

If electric power is applied to the printer 300, the control unit 350 controls the overall operations of the printer 300 according to the control programs stored in the memory unit 330.

The control unit 350 determines when language information corresponding to a display language set in the printer driver 135 has been received from the computer 100 through the PC interface unit 320. Upon determining that the language information corresponding to the display language set in the printer driver 135 has been received, the control unit 350 sets the display language of the printer based on the language information corresponding to the display language set in the printer driver 135. The display language of the printer 300 is the language selected for displaying information on the display part 314. Subsequently, menu information, option information, and message information for displaying the operational status of the printer 300, and so on, which are set in the printer 300, is displayed on the display part 314.

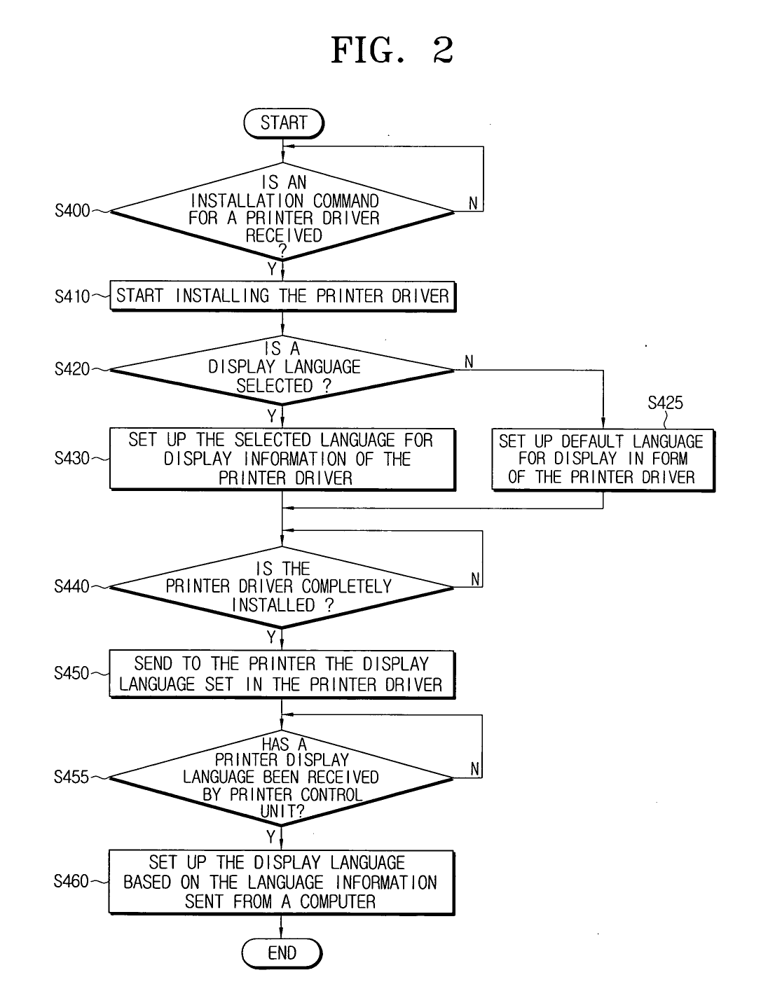

Hereinafter, descriptions will be made on an automatic language setting method for a printer in a print system according to a preferred embodiment of the present invention with reference to FIG. 2.

The automatic language setting method begins with step S400 when the CPU 150 of the computer 100 determines whether an installation command for the printer driver 135 has been received through the input unit 110 (decision step S400). If the CPU 150 decides that the installation command for the printer driver 135 has been received (“Yes” path from decision step S400), the CPU 150 runs a printer driver program to install the printer driver 135 in the memory unit 130 (S410). During the installation of the printer driver program in the memory unit 130, the CPU 150 displays a printer driver installation window on the display unit 120. If no installation command has been received (“No” path from decision step S400), the CPU 150 continuously monitors input unit 110, in anticipation of receiving this or other commands.

The CPU 150 then determines whether a language has been selected for displaying a printer driver registration information setting window through the input unit 110 (decision step S420). If the CPU 150 receives a selection signal for any of multiple languages provided on the printer driver installation window through the input unit 110 (“Yes” path from decision step S420), the CPU 150 sends the selected language information to the printer driver 135 to set the selected language information as a display language of the printer driver 135 (S430). On the contrary, if the CPU 150 determines that a display language has not been selected in decision step S420, the CPU 150 sends to the printer driver 135 language information set as the default language information in order to set the default language as the display language of the printer driver 135 (S425). In The language information set as the default language indicates information corresponding to the languages set for the operating system of the computer 100 (e.g., Windows 2000).

The CPU 150 the determines whether the printer driver 135 is completely installed (decision step S440). If the CPU 150 determines that the printer driver 135 is completely installed “(Yes” path from decision step S440), the CPU 150 transfers to the printer 300 language information corresponding to the display language set in the printer driver 135 (S450). For example, in case that “Korean” is set for a display language to the printer driver 135, the printer driver 135 transfers to the printer 300 information corresponding to the “Korean”. If the printer driver 135 has not been completely installed (“No” path from decision step S440), the CPU 150 continues to monitor installation of the printer driver 135.

Subsequently, the control unit 350 of printer 300 determines whether information corresponding to the display language set in the printer driver 135 has been received from the computer 100 through the PC interface unit 320 (decision step S455). If the control unit 350 determines that the information corresponding to the display language set in the printer driver 135 has been received (“yes” path from decision step S455), the control unit 350 sets the display language of the printer 300 based on language information corresponding to the received display language (S460). If all the information pertaining to the set display language has not been received by the control unit 350n (“No” path from decision step S455), the control unit 350 continues to monitor the PC interface unit 320 for this, and other data/commands. Thereafter, all information to be displayed on the display part 314 is displayed in a language corresponding to the display language set in the printer 300. For example, in the event that information sent from the computer 100 in correspondence with the display language is information corresponding to the language “Korean”, “Korean” language is automatically set up for the display language of the printer 300. Accordingly, all information to be displayed on the display part 314 thereafter is displayed in the Korean language. This indicates that the control unit 350 selects the firmware prepared in the Korean language from multiple firmwares recorded in the memory unit 130.

As discussed above, the descriptions provided above have been made in regard to a printer 300 as an example of a print apparatus connected to a host device. However, as one skilled in the art of the invention can appreciate, the various embodiments of the present invention can be applied to a combination office device having the functions of a printer, facsimile machine, scanner, and photocopier, and as such, are not limited to only that of a printer 300. Furthermore, the embodiments of the present invention can be applied to all electronic devices communicating with a host device connected through a communication interface and equipped with a display unit for display information.

Further as described above, since the automatic display language setting method for the print apparatus according to the embodiments of the present invention are constructed to automatically set up the display language of the print apparatus based on information provided from a host device rather than manually setting up the display language of the print apparatus through a manipulation panel by users, there exists an advantage that convenient manipulations can be provided to the users.

Although the embodiment of the present invention has been described, it will be understood by those skilled in the art that the present invention should not be limited to the described embodiment, but various changes and modifications can be made within the spirit and scope of the present invention as defined by the appended claims.

What is claimed is:

1. A print apparatus, comprising:
a display unit;
an interface adapted to communicate with a host device; and
a control unit for determining whether certain language information from the host device has been received through the interface, and, if it is determined that the language information has been received, displaying display information on the display unit in a language corresponding to the language information.

2. The print apparatus as claimed in claim 1, wherein the language information is display language information of a device driver set when the device driver is installed in the host device to control operation of the print apparatus.

3. The print apparatus as claimed in claim 1, wherein the information to be displayed on the display unit includes menu information, option information, and message information displaying an operational status of the print apparatus which are set in the print apparatus.

4. An automatic display language setting method for a print apparatus connected to a host device through a communication interface and communicating with the host device through the communication interface, comprising steps of:
determining whether certain language information has been received through the communication interface from the host device; and
setting up a display language of a print apparatus to display information to be displayed on a display unit of the print apparatus in a language corresponding to the language information if it is determined that the language information is received from the host device.

5. The automatic display language setting method as claimed in claim 4, wherein the language information received from the host device is display language information of a device driver which is set when the device driver for controlling operation of the print apparatus is set up in the host device.

6. The automatic display language setting method as claimed in claim 4, wherein the print apparatus includes a facsimile machine, a printer, and a combination device providing functions of the facsimile machine and the printer.

7. An automatic display language setting method for a print apparatus in a print system having a host device connected through the print apparatus and a communication interface, comprising:
sending to the print apparatus display language information of a device driver which is set when the device driver for controlling operation of the print apparatus is set up in the host device;
determining whether the display language information of the device driver has been received from the host device; and
setting up a display language of the print apparatus to display information to be displayed on a display unit of the print apparatus in a language corresponding to the display language information of the device driver, if it is determined that the display language information of the device driver has been received from the host device.

8. The automatic display language setting method as claimed in claim 7, wherein the sending step comprises:
setting up the device driver in a memory of the host device if an installation command for the device driver has been received;
selecting the display language of the device driver; and
sending to the print apparatus the display language information of the device driver to set up the display language of the print apparatus in the same language as the display language of the device driver.

9. The automatic display language setting method as claimed in claim 7, wherein the print apparatus includes a facsimile, a printer, and a combination device providing functions of the facsimile and the printer.
